(19) United States
(12) Patent Application Publication
(10) Pub. No.: US 2017/0228206 A1
(43) Pub. Date: Aug. 10, 2017

(54) PROCESSING DATA IN A THIN CLIENT TERMINAL

(71) Applicant: Hewlett-Packard Development Company, L.P., Houston, TX (US)

(72) Inventors: Daniel BUNGERT, Fort Collins, CO (US); Ryan Michael CLEMENS, Fort Collins, CO (US); Matthieu CLEMENCEAU, Houston, TX (US)

(21) Appl. No.: 15/521,771

(22) PCT Filed: Dec. 16, 2014
(86) PCT No.: PCT/US2014/070679

§ 371 Date: Apr. 25, 2017

(51) Int. Cl. G06F 3/147; H04N 19/61; H04L 29/06; G06T 1/20; G09G 5/00

(52) U.S. Cl. CPC G06F 3/147; G06T 1/20; G09G 5/006; H04L 67/42; H04N 19/61; G09G 2370/022; G09G 2340/02

(57) ABSTRACT

An example method for processing data in a thin client terminal in accordance with aspects of the present disclosure includes receiving, by a processing unit, at least one set of data from a server; decoding, by a hardware decoder, the at least one set of data based on a custom library; and outputting, by a graphical processing unit, the at least one set of decoded data to at least one display unit.

### BACKGROUND

A thin client-server system uses a low-price and dedicated information processing apparatus having the minimum functions such as displaying on a screen, inputting by use of a key or a mouse, or the like. The information processing apparatus is called a thin client terminal. A thin client terminal is connected through a network with a server which unifies management of all resources of an application or the like. According to the thin client-server system, the server holds a program, data, a file of the application or the like, and the application is processed by use of a memory area which is reserved virtually in the server. A process executed by the thin client terminal is limited to a process of inputting and outputting data, and a process of displaying and handling an image on a screen. Consequently, the thin client terminal may work in an environment of a small memory and low power CPUs, since almost all processes are executed only by use of resource of the server.

### BRIEF DESCRIPTION OF THE DRAWINGS

Some examples are described with respect to the following figures:

FIG. 1 illustrates a thin client terminal in accordance with an implementation of the present disclosure; and

FIG. 2 illustrates an example process flow diagram in accordance with an implementation.

### DETAILED DESCRIPTION

The following terminology is understood to mean the following when recited by the specification or the claims. The singular forms “a,” “an,” and “the” mean “one or more.” The terms “including” and “having” are intended to have the same inclusive meaning as the term “comprising.”

Various implementations described herein are directed to remote workstation thin computing. More specifically, and as described in greater detail below, various aspects of the present disclosure are directed to a manner by which a graphics card multimedia decode hardware in a thin client system is repurposed to delivery high performance at less central processing unit (CPU) usage.

Aspects of the present disclosure described herein implement a thin client system that allows high client performance while utilizing low cost platforms. The thin client system does not require specialized protocols with special hardware o both the client and server side, or optimized client code. The thin client system utilizes a hardware solution and does not use a software based decoder that may require a strong local CPU.

According to various aspects of the present disclosure, the approach described herein allows using a custom H.264 library for use with a client protocol, leveraging the hardware multimedia decode capability of a graphical processing unit that may be in the thin client, Such aspects, among other things, increase performance of remote desktop sessions while keeping the per-frame latency low (e.g., decoding at near 60 frames per second for a single monitor case).

In one example in accordance with the present disclosure, a method for processing data in a thin client terminal is provided. The method comprises receiving, by a processing unit, at least one set of data from a server, decoding, by a hardware decoder, the at least one set of data based on a custom library, and outputting, by a graphical processing unit, the at least one set of decoded data to at least one display unit.

In another example in accordance with the present disclosure, a thin client terminal is provided. The thin client terminal comprises a communication processing unit that transmits and receives data, and a graphics card having a hardware decoder to decode the data. The hardware decoder decodes the data based on a custom library.

In a further example in accordance with the present disclosure, a non-transitory computer-readable medium is provided. The non-transitory computer-readable medium comprises instructions that when executed cause a device to (i) issue a data acquisition request to a server through a processing unit transmitting and receiving data, and (ii) use a hardware decoder based on a custom library to decode the data.

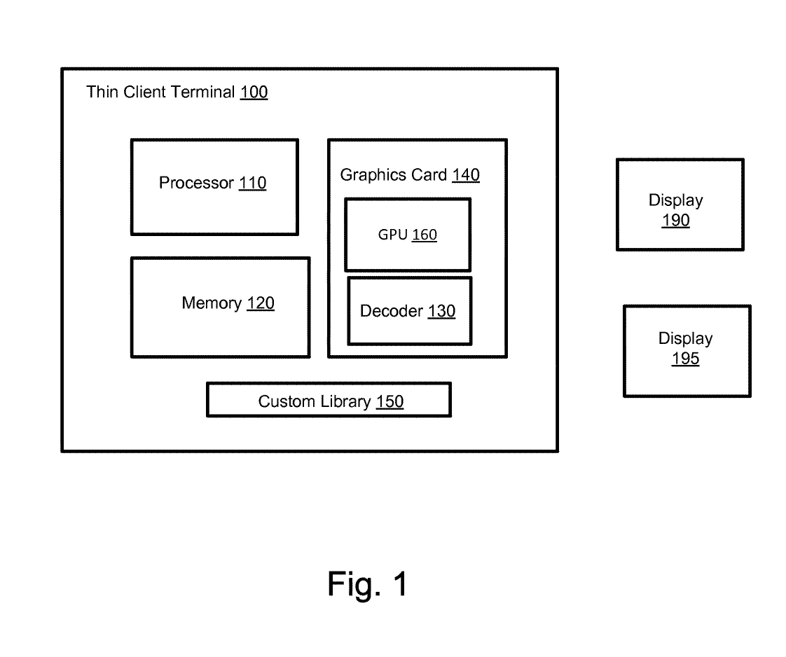

FIG. 1 illustrates an example thin client terminal 100 in accordance with an implementation. The thin client terminal 100 may be a part of a remote computing system, and the thin client terminal 100 may be connected to a server (e.g., secure data center), and at least one display. FIG. 1 illustrates two displays 190 and 195. However, it should be readily apparent that FIG. 1 represents a generalized depiction and that other components may be added or existing components may be removed, modified, or rearranged without departing from a scope of the present disclosure. Moreover, although the two displays 190 and 195 are shown in FIG. 1, in other implementations, the thin client terminal may be connected to more or less than 2 displays.

In one implementation, a thin client terminal 100 according to the present invention may be used in a thin client-server system in which a server may have a database to store user data. The server and the thin client terminal 100 that acquires the user data from the server may be connected to each other through a network. In one example, the thin client terminal 100 may be connected with the network by use of wireless communication. The server may include a database which stores data, and transmits the data in response to a request issued by the thin client terminal. The server component in addition to a communication processing unit of the server, which transmits and receives data, are omitted in FIG. 1. Such data may include remote desktop session data. More specifically, the remote desktop session data comprises data related to any program or commands running on the desktop session (e.g., opening a new file, minimizing a window, playing a video). More specifically, the data may include graphics data.

In one implementation, the data is delivered to the thin client terminal 100 in a compressed format. More specifically, streams of data are split out and compressed using advanced algorithms. For example, in one implementation, the Huffman encoding algorithm may be used. The Huffman encoding algorithm is an optimal compression algorithm when only the frequency of individual letters are used to compress the data.

In one implementation, it is possible that a plurality of users can share the server. Moreover, it may be applicable that the server has an authentication function (authentication unit) in order to determine whether an access to the database is permitted or not (whether download from the database is permitted or not). A password lock, an IC (Integrated Circuit) card authentication, a face authentication, a fingerprint authentication or alike may be applicable as the authentication method. Moreover, it is also possible that the server identifies each user by use of identification information (for example, IP address) which is assigned to each thin client terminal.

The thin client terminal 100 comprises a processor 110, a memory 120, a hardware decoder 130 and graphics processing unit 160 on graphics card 140 and a custom decoder library 150, each of which is described in greater detail below. In one implementation, the thin client terminal 100 may comprise a communication processing unit. The communication processing unit communication may transmit and receive information through the network.

The thin client terminal 100 includes the processor 110 for executing instructions such as those described below in the methods herein. The processor 110 may, for example, be a microprocessor, a microcontroller, a programmable gate array, an application specific integrated circuit (ASIC), a computer processor, or the like. The processor 110 may, for example, include multiple cores on a chip, multiple cores across multiple chips, multiple cores across multiple devices, or combinations thereof. In some examples, the processor 110 may include at least one integrated circuit (IC), other control logic, other electronic circuits, or combinations thereof.

The processor 110 may be in communication with a computer-readable storage medium 120 (e.g., memory) via a communication bus. The computer-readable storage medium 120 may include a single medium or multiple media. For example, the computer readable storage medium 120 may include one or both of a memory of the ASIC, and a separate memory in the thin client terminal 100. The computer readable storage medium 120 may be any electronic, magnetic, optical, or other physical storage device. For example, the computer-readable storage medium 120 may be, for example, random access memory (RAM), static memory, read only memory, an electrically erasable programmable read-only memory (EEPROM), a hard drive, an optical drive, a storage drive, a CD, a DVD, and the like. The computer-readable storage medium 120 may be non-transitory. The computer-readable storage medium 120 may store, encode, or carry computer executable instructions that, when executed by the processor 110, may cause the processor 110 to perform steps of any of the methods or operations disclosed herein according to various examples. Some of the instructions may include issueing a data acquisition request to a server through a processing unit transmitting and receiving data, and using a hardware decoder based on a custom library to decode the data.

Moreover, the displays 190 and 195 may be communicatively coupled to the processor 110 and computer-readable medium 120 via the communication bus. The display 115 may incorporate any technology, for example liquid crystal display (LCD) technology; light emitting diode (LED); organic LED (OLED); active matrix OLED (AMOLED); or any other display technology.

The thin client terminal 100 comprises the hardware decoder 130 on the graphics card 140. The graphics card 140 is an actual, physical, graphics card used to provide high quality and/or high performance graphics capabilities to the remote session. More specifically, the graphics card 140 includes any mechanism capable of receiving data and/or commands and providing data and/or commands usable by a device such as a display (e.g., display 190 or 195) to create images. A user communicates with one or more applications in the thin client terminal 100. The applications use a driver to communicate graphical commands and data (e.g., video data) to the graphical card 140 for display on the display 190 and/or 195.

The processor 110 in the thin client terminal 100 receives the data from the server and generates commands that result in the writing of the data to the graphics card 140 for display on the display 190. In one implementation, the data sent by the server is encoded. For example, the data may be encoded to H.264 format. More specifically, H.264 is an example of a compression codec for the graphics data. In such implementation, the processor 110 identifies a library (e.g., the custom decoder library 150) to decode the data. The custom decoder library 160 comprises instructions, one of which may instruct to utilize the hardware decoder 130 to decode the data. Accordingly, based on the instructions from the custom decoder library 150, the hardware decoder 130 decompresses the data before the data is sent to the display 190. The hardware decoder 130 displays the decoded data directly to the display 190 with minimal latency. In one implementation, the performance of the hardware decoder 130 is shown to be greater than linear with higher resolutions of the display or the higher number of the displays.

In another implementation, the hardware decoder 130 decodes two sets of data received from the server, and displays each set on one monitor. For example, a first set of data decoded by the hardware decoder 130 is displayed on the display 190, and the second set of data decoded by the hardware decoder 130 is displayed on the display 195.

In one implementation, the new decoder library 150 is a custom H.264 library for use with the Citrix client that leverages the hardware multimedia decode capabilities of the processor 110 in the thin client terminal 100. The new decoder library 150 replaces an original Citrix H.264 decoding library for an interface compatible alternative that offloads the H.264 decoding to the processor. In other implementations, such custom decoder library may be applied to other protocols, such as RDP, RGS and VMware.

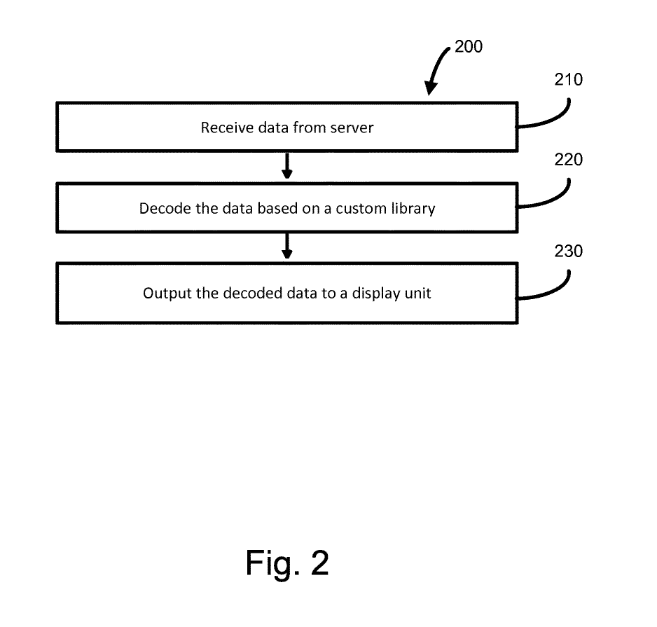

Turning now to the operation of the thin client terminal 100 of FIG. 1, FIG. 2 illustrates an example process flow diagram 200 in accordance with an implementation. It should be readily apparent that the processes illustrated in FIG. 2 represents generalized illustrations, and that other processes may be added or existing processes may be removed, modified, or rearranged without departing from the scope and spirit of the present disclosure. Further, it should be understood that the processes may represent executable instructions stored on memory that may cause a processor to respond, to perform actions, to change states, and/or to make decisions. Thus, the described processes may be implemented as executable instructions and/or operations provided by a memory associated with the thin client terminal 100. Furthermore, FIG. 2 is not intended to limit the implementation of the described implementations, but rather the figure illustrates functional information one skilled in the art could use to design/fabricate circuits, generate software, or use a combination of hardware and software to perform the illustrated processes. Also, the various operations depicted in FIG. 2 may be performed in the order shown or in a different order and two or more of the operations may be performed in parallel instead of serially.

The process 200 may begin at block 210. A processing unit in the thin client terminal receives at least one set of data from a server. In one implementation, the transfer of data from the server to the thin client terminal may be initiated by a user request. The data includes graphics data (e.g., screen data), which are compressed using advanced algorithms at the server. At block 220, a hardware decoder in the thin client terminal decodes the at least one set of data based on a custom library. In this implementation, the hardware decoder replaces the processor in handling the decoding process. Accordingly, the hardware decode of the protocol data is done using an off-the-shelf hardware. This helps avoid a bottleneck at the processor due to the large number of advanced operations required to decompress/decode and display the graphics data. In one implementation, the custom library may be a custom H.264 library, and such custom library may offload the H.264 decoding the hardware decoder on the graphical processing unit on the graphics card of the thin client terminal. At block 230, the graphical processing unit in the thin client terminal outputs the at least one set of decoded data to at least one display unit. In an implementation with multiple sets of data, each set may be displayed on a single display.

All of the features disclosed in this specification (including any accompanying claims, abstract and drawings), and/or all of the steps of any method or process so disclosed, may be combined in any combination, except combinations where at least some of such features and/or steps are mutually exclusive.

In the foregoing description, numerous details are set forth to provide an understanding of the subject disclosed herein. However, examples may be practiced without some or all of these details. Other examples may include modifications and variations from the details discussed above. It is intended that the appended claims cover such modifications and variations.

What is claimed is:

1. A method for processing data in a thin client terminal, comprising:
receiving, by a processing unit, at least one set of data from a server;
decoding, by a hardware decoder, the at least one set of data based on a custom library; and
outputting, by a graphical processing unit, the at least one set of decoded data to at least one display unit.

2. The method of claim 1, wherein the thin client terminal is in a thin client-server system in which the server having a database to store the data, and the thin client terminal acquiring the data from the server are connected each other through a network.

3. The method of claim 1, further comprising issuing a data acquisition request to the server through the communication processing unit which transmits and receives the at least one set of data.

4. The method of claim 1, wherein the at least one set of data received from the server is encoded in a H.264 format.

5. The method of claim 1, wherein the custom library is a custom H.264 library for use with a Citrix client.

6. The method of claim 1, wherein the at least one set of data comprises two sets of data, and each set of data is displayed on one display unit.

7. The method of claim 6, wherein the two sets of data share the hardware decoder.

8. A thin client terminal, comprising:
a communication processing unit that transmits and receives data; and
a graphics card having a hardware decoder to decode the data, wherein the hardware decoder decodes the data based on a custom library.

9. The thin client terminal of claim 8, wherein the custom library specifies the hardware decoder to be used for decoding the data.

10. The thin client terminal of claim 8, wherein the decoded data is displayed on at least one display unit.

11. The thin client terminal of claim 10, wherein the data includes a plurality of data sets, and the communication processing unit creates one stream for each data set, wherein each stream is displayed on one display unit.

12. A non-transitory computer-readable medium comprising instructions that when executed cause a system to:
issue a data acquisition request to a server through a processing unit transmitting and receiving data; and
use a hardware decoder based on a custom library to decode the data.

13. The non-transitory computer-readable medium of claim 12, further comprising instructions to output the decoded data on a display unit.

14. The non-transitory computer-readable medium of claim 12, wherein the custom library is a H.264 decoding library and offloads H.264 decoding to the hardware decoder.

15. The non-transitory computer-readable medium of claim 12, wherein the system is a Citrix remote desktop protocol.
